(19) United States
(12) Patent Application Publication
(10) Pub. No.: US 2005/0088417 A1
(43) Pub. Date: Apr. 28, 2005

(54) Tactile touch-sensing system

(76) Inventor: Roger C. Mulligan, White Rock (CA)

Correspondence Address: 3M INNOVATIVE PROPERTIES COMPANY, PO BOX 33427, ST. PAUL, MN, 55133-3427, US

(21) Appl. No.: 10/693,402

(22) Filed: Oct. 24, 2003

(51) Int. Cl. G09G 5/00

(52) U.S. Cl. 345/173

(57) ABSTRACT

A tactile touch-sensing system that includes a touch sensor, touch-generating pads, and tactile buttons. The touch sensor is configured to produce an electrical signal in response to a touch. The touch-generating pads cover at least a part of the touch sensor and are configured not to cause a touch on the touch sensor before they are activated. A user can activate a touch-generating pad by pressing a tactile button associated with the touch-generating pad. In response to being pressed, the tactile button is configured to provide tactile feedback to the user. The touch-generating pad, when activated by the tactile button, causes a touch on the touch sensor.

### BACKGROUND

As computers and other electronic devices become more ubiquitous, touch-sensing systems are becoming more prevalent as a means for inputting data. For example, touch-sensing systems may now be found in workshops, warehouses, manufacturing facilities, restaurants, on hand-held personal digital assistants, automatic teller machines, casino game-machines, and the like.

A touch-sensing system often includes a touch sensor and a display device. The display device usually includes a display screen for presenting graphical information to users. A touch sensor ordinarily includes a transparent sensing circuit placed on top of the display screen for sensing the position of a touch on the screen. Touch-sensitive displays are often used as a replacement for conventional hardware input devices. For example, the display screen may be used to illustrate icons that look like buttons. A user may touch the screen in the location of the icon, resulting in a signal corresponding to the button. The result is as if the user had “pressed” the button.

In many ways, touch-sensing systems are superior to conventional input systems with buttons and switches. For example, because touch-sensing systems typically have few or even no moving parts, they are also more reliable than conventional input system. In addition, a touch-sensing system can be programmed to change button meanings dynamically. This provides a flexible and user-friendly input mechanism that can be custom-tailored for a specific application or context. Control mechanisms in a touch-sensing system may be consolidated by presenting input selections to the user in multiple layers of menus, saving space and manufacturing cost.

While touch-sensing systems are gradually replacing conventional input systems in many applications, there are still some applications where touch-sensing systems are not viewed as acceptable. One criticism of touch-sensing systems is their failure to provide tactile feedback. Tactile feedback allows a user to know, by a sense of touch, whether he has located the right input mechanism or has successfully entered an input. In many operating environments and applications of electronic devices, tactile feedback is often the only safe and effective means of providing feedback to a user. Visual and audible feedback is sometimes used. However, if an electronic device is used in an environment where ambient noise is intense or lighting is limited, auditory or visual feedback may not be effective. Similarly, tactile feedback may be the only viable option for a user who has visual or hearing impairments.

Tactile switches have been provided as separate elements having their own associated electronics and circuitry in a system that also includes a touch screen. In another application, a resistive touch screen was modified so that discrete areas of the touch screen behave like tactile switches. A spacer adhesive was positioned between the top and bottom substrates of a 4-wire resistive touch screen and covering a portion of the active area. Round apertures were made in the spacer adhesive to define discrete areas where contact could be made between the top and bottom substrates under a sufficient touch force. Metal snap domes were placed over the aperture regions and secured in place. When the snap dome was pressed, the center dimple of the snap dome would make the conductive surface of the top substrate of the touch screen contact the lower conductive surface in a specific location. The portion of the touch screen outside of the area covered by the spacer adhesive could be used as a conventional resistive touch screen.

### SUMMARY OF THE INVENTION

Briefly stated, the present invention is directed to a tactile touch-sensing system that includes a touch sensor, touch-generating pads, and tactile buttons. The touch sensor is configured to produce an electrical signal in response to a touch. The touch-generating pads are positioned proximate to the touch sensor and are configured so that they do not cause a detectable touch on the touch sensor until they are activated. A user can activate a touch-generating pad by pressing a tactile button associated with the touch-generating pad. The tactile button may be in close proximity to the touch-generating pad, or may be remotely located from the touch-generating pad but still capable of activating the touch-generating pad. A one-to-one correspondence of tactile buttons to touch-generating pads is not required. The touch-generating pad can be positioned in any location proximate to the touch screen where activation of the touch pad can be detected as a touch on the touch sensor. For example, the pad can be located in front of the touch sensor, behind the touch sensor, along the periphery of the touch senor, and so forth.

In response to being pressed, the tactile button is configured to provide tactile feedback to the user and to activate the touch-generating pad. The touch-generating pad, when activated by the tactile button, causes a detectable touch on the touch sensor. In this way, tactile button activation can be detected by the touch sensor, as opposed to detection only by separate circuitry associated with the tactile button. In some designs, it may be desirable to be able to detect touch pad activation by the touch sensor as well as by circuitry dedicated to the touch pad. This may provide additional signals that can be used for calibration, diagnostics, redundancy, or to access additional functionalities.

The present invention provides a simple way to configure a touch-sensing system to provide users with tactile feedback. Conventional touch-sensing systems typically have a smooth, one-piece surface for receiving touches and essentially provide no tactile feedback. The tactile touch-sensing system of the present invention provides tactile feedback to the user without the cost and complication associated with adding a conventional control circuit with buttons and switches to an ordinary touch-sensing system.

### BRIEF DESCRIPTION OF THE DRAWINGS

The invention may be more completely understood in consideration of the following detailed description of various embodiments of the invention in connection with the accompanying drawings, in which:

FIG. 1 is a schematic representation of one implementation of the present invention, showing an exemplary tactile touch-sensing system;

FIG. 2 is an exploded view of an exemplary embodiment of a tactile touch-sensing system;

FIG. 3 is a frontal view of the tactile touch-sensing system shown in FIG. 2;

FIG. 4 is a cross-sectional view of an exemplary tactile button; and

FIG. 5 is another cross-sectional view of the exemplary button shown in FIG. 4.

The drawings are schematic and illustrative, indicating functional relationships of various elements, and not necessarily particular spatial relationships among the various elements. While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE PREFERRED EMBODIMENT

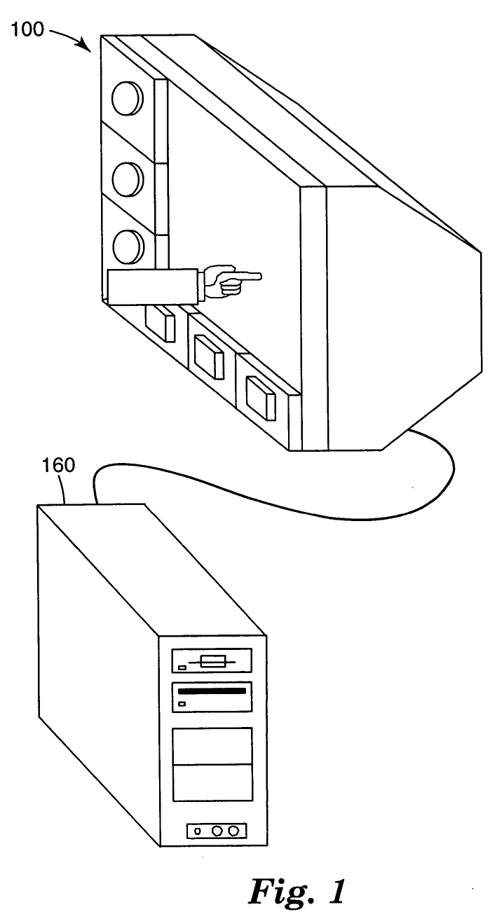

FIG. 1 is a schematic representation of one implementation of the present invention, showing an exemplary tactile touch-sensing system 100. Tactile touch-sensing system 100 enables a user to enter inputs to an electronic device, such as computer 160, and provides the user with tactile feedback. Typically, tactile touch-sensing system 100 enables computer 160 to display information for interacting with the user.

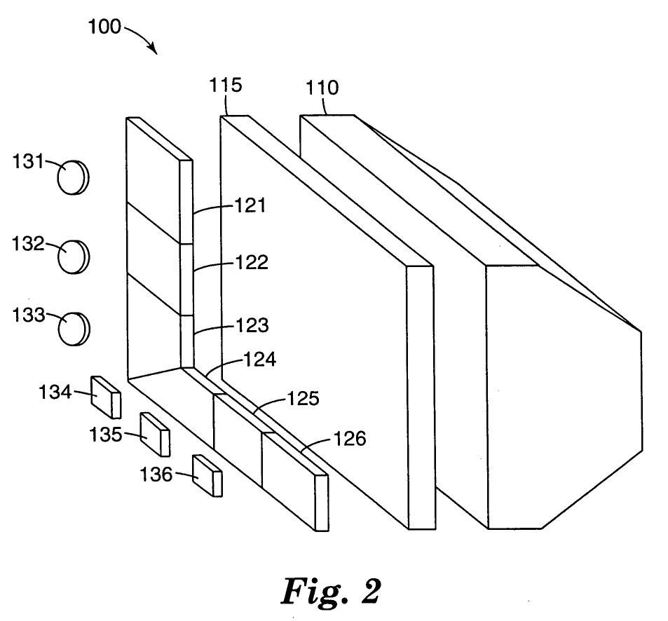

Tactile touch-sensing system 100 may include many components, which will be discussed in more detailed in conjunction with FIG. 2. Typically, tactile touch-sensing system 100 includes a touch sensor configured to generate signals in response to a touch on the touch sensor. For tactile touch-sensing system 100, a user can touch the touch sensor directly or indirectly through a touch-generating pad, which will be discussed in detail in conjunction with FIG. 2. Tactile touch-sensing system 100 may also include a control circuit that is configured to process the signals and transmit the results to computer 160 for further processing.

FIG. 2 is an exploded view of an exemplary embodiment of tactile touch-sensing system 100. FIG. 2 only illustrates principle components of tactile touch-sensing system 100. Other components may be added without deviating from the principles of the invention.

Tactile touch-sensing system 100 enables an electronic device to display information to users and to receive inputs from the user. In this embodiment, tactile touch-sensing system 100 includes a display screen 110, a touch sensor 115, touch-generating pads 121-126, and tactile buttons 131-136. Tactile touch-sensing system 100 may also include a control circuit (not shown).

Display screen 110 is a component of tactile touch-sensing system 100 for displaying information to users. For example, display screen 110 may be a cathode-ray tube (CRT), liquid crystal display (LCD), plasma display, OLED, or any other suitable display. Display screen 110 enables tactile touch-sensing system 100 to display information from the electronic device. The information may include selections of inputs that the user may make through tactile touch-sensing system 100. Although FIG. 2 shows a configuration where display screen 110 is viewed through touch sensor 115, the present invention is also applicable to configurations where the touch sensor is not transparent or is not disposed over a display.

Touch sensor 115 is a component of tactile touch-sensing system 100 for detecting a touch. Touch sensor 115 may be one of the many types of touch-sensitive screen technologies. For example, touch sensor 115 may be a capacitive touch sensor (for example, an analog capacitive sensor or a projected capacitive sensor), a resistive touch sensor, an optical touch sensor, an acoustic touch sensor, a force sensor, a vibration touch sensor, or any other suitable touch sensor whether now known or later developed. Various of these technologies are described briefly below.

A capacitive touch sensor includes at least one conductive layer. The conductive layer is usually energized by an oscillator circuit. When a user touches the display screen, a signal is generated as a result of a capacitive coupling between the user and the conductive layer. The signal is converted to the location of the touch by a sensing circuit.

A resistive touch sensor typically includes two transparent conductive layers separated by spacer dots. When a touch forces the two conductive layers to come into contact, the resulting voltage is sensed and the location of the touch is computed.

Optical touch sensor generally includes arrays of light emitters and photo detector pairs. The light emitters and the photo detectors are mounted at the edge of a display screen on opposite sides. Each of the light emitters emanates a light beam across the display screen to a corresponding photo detector on the opposite side. When a user touches the display screen, one or more of the light beams are blocked, causing signals to be generated. The position of the touch is calculated from the signals.

Surface and guided acoustic wave touch sensors utilize acoustic waves traveling over the surface of a screen at precise speeds in straight lines. Transmitting transducers are located along the horizontal and vertical edges of the screen. Corresponding receiving transducers are located at the opposite edges of the screen. A reflective array is printed along the edges of the screen. In operation, the transducer generates a surface acoustic wave that travels along the axis of the reflector array. At each reflector element, a small amount of the energy in the wave is deflected orthogonal to the direction of the wave, travels over the surface of the glass and is again orthogonally deflected toward the receiving transducer by a mirror image reflector. Since the energy in the wave is reduced as it travels the length of the reflective array, the reflector elements are placed increasingly closer together to compensate for the decreasing energy level. When a user touches the screen, a portion of the energy is absorbed by the touch. This reduced energy level is detected and, by comparing the speed of the received signal with the known speed of the surface acoustic waves on the screen, the touch location is calculated.

Vibration-sensing touch sensors use vibration-sensing elements such as piezoelectric sensors to detect vibrations generated by the impact of a touch. A touch input can cause vibrations in the touch plate that propagate from the location of the touch to the vibration sensors. From information related to the time differentials at which the vibration signal is received at each of the vibration sensors, the location of the touch can be calculated. Alternatively, a vibration emitter can be used to emit known vibrations in the touch plate that are altered under the influence of a touch event. The altered vibrations can be similarly detected by the vibration sensors to determine the touch location. Examples of vibration-sensing touch sensors are disclosed in International Publication WO 01/48684.

The types of touch sensors identified above are known in the art and will not be discussed in more detail. For simplicity, the following discussion will focus on a tactile touch-sensing system with a capacitive sensor.

Touch sensor 115 is positioned in front of display screen 110. Preferably, touch sensor 115 covers most of or the entire display screen 110. In some embodiments, touch sensor 115 is larger than the display, defining a border area outside of the display area. In some embodiments, it may be desirable to locate the tactile buttons and/or touch-generating pads within such a border area so as not to detract from the viewability of the display. In response to a touch, touch sensor 115 senses the touch and transmits signals related to the touch to the electronic device. The position of the touch may be computed by the control circuit of touch-sensing system 100 from those signals.

Touch-generating pads 121-126 are components of tactile touch-sensing system 100 for generating a touch on touch sensor 115. Each of the touch-generating pads 121-126 is associated with a corresponding tactile button 131-136. Touch generating pads 121-126 may be printed onto the surface of touch sensor 115. Touch-generating pads 121-126 may also be separate components that can be detachably or permanently attached to touch sensor 115. In an inactive state, touch-generating pads 121-126 can be configured to “float”, meaning that they are not tied to any particular signal source, and are thus “invisible” to the sensing electronics. To be used on a system with a capacitive touch sensor, touch-generating pads 121-126 are configured to undergo an electrical change when activated, such as a change in electrical potential or a change in drive frequency, that can be detected by the touch sensor as a “touch.” Touch-generating pads 121-126 can be activated in this manner when they are coupled to their corresponding tactile buttons 131-136.

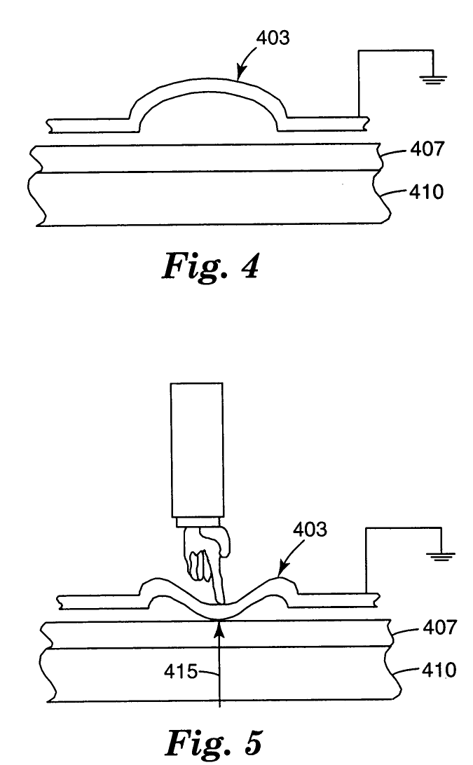

Tactile buttons 131-136 are components of tactile touch-sensing system 100 for providing tactile feedback to users. Each of the buttons 131-136 is configured such that when it is pressed by a user, the button electrically couples to its corresponding touch-generating pad 121-126, thereby driving the touch generating pad 121-126 to some known potential or at some known frequency, thereby causing a “touch” on touch sensor 115. Tactile feedback provided by tactile buttons 131-136 will be discussed in detail in conjunction with FIG. 4. Briefly stated, tactile feedback enables a user to know whether a tactile button has been properly activated.

Tactile buttons 131-136 may include many types of mechanisms, such as snap domes used in membrane switches, silicone elastomeric buttons, rocker switches, carbon buttons, or the like. Tactile buttons 131-136 may be fitted with key caps, printed or raised symbols, or the like, to enhance the functionalities of tactile buttons 131-136. For example, the buttons may be configured with lights pipes to light the buttons for applications in a low lighting environment. In other examples, the buttons may be configured to provide various types of sensory feedback, key lights, sounds, solenoid hits, etc. Any other feature that can be suitably added to any conventional tactile switch or button can also be incorporated into the present invention.

For use with a capacitive touch sensor, each of the tactile buttons 131-136 is configured to cause a corresponding touch-generating pad to capacitively couple with touch sensor 115. In one embodiment, tactile buttons 131-136 are electrically connected to an electrical potential that is different from the potential of their corresponding touch-generating pads 121-126 in an inactive state. For example, tactile buttons 131-136 may be electrically grounded. In another embodiment, carbon tactile buttons may be used to directly short the user's finger to touch sensor 115 and may be used without a touch-generating pad.

In operation, when one of the tactile buttons 131-136 is pressed, the tactile button and its corresponding touch-generating pad come into contact and become electrically connected. As a result, the electrical state of the touch-generating pad is changed from its inactive state to a state that can be detected by the touch sensor. For example, the electrical potential of the touch-generating pad can be change from a potential that is invisible to the touch sensor to another potential. The change in electrical potential causes a capacitive coupling between touch sensor 115 and the touch-generating pad that can be detected as a touch on touch sensor 115 similar to a human touch. The coordinates of the button are reported in the same way as a normal touch on touch sensor 115. The coordinates may be used to represent a pressed button on the electronic device.

Touch-generating pads 121-126 and tactile buttons 131-136 may also be configured to work with other types of touch sensors in addition to capacitive touch sensors. For example, touch-generating pads 121-126 and tactile buttons 131-136 for a resistive touch sensor or a force touch sensor may include mechanisms to ensure positive, mechanical contact with the touch sensor sufficient to cause a touch. For an optical sensor, touch-generating pads 121-126 may be configured to allow sensor light beams to pass through in an inactive state and to block the light beams when activated by tactile buttons 131-136. Similarly, touch-generating pads 121-126 for a surface acoustic wave sensor may absorb the energy of the generated acoustic waves only when activated by tactile buttons 131-136. Touch-generating pads 121-126 for vibration sensing touch sensors may include mechanisms to ensure an impact with the touch sensor sufficient to cause vibrations in the touch sensor that can be detected as a touch. In other instances, the touch generating pads can include transducers such as piezoelectric devices configured to emit vibrations when activated.

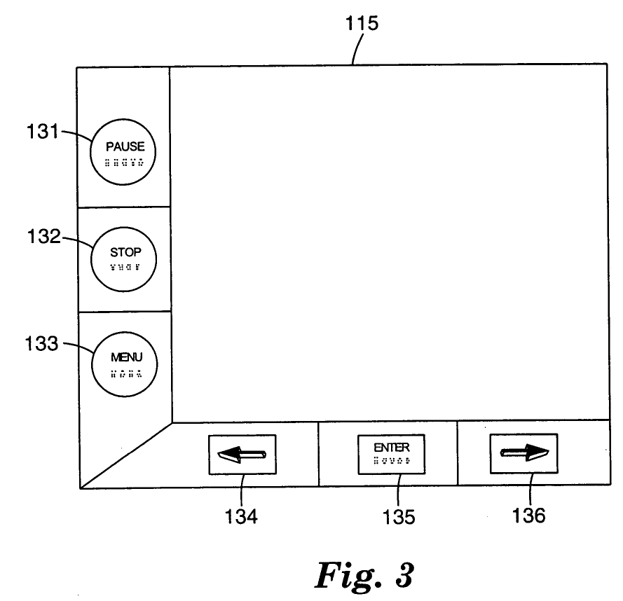

FIG. 3 is a frontal view of tactile touch-sensing system 100 shown in FIG. 2. As shown in the figure, touch-generating pads 121-126 cover a portion of touch sensor 115. Tactile buttons 131-136 are shown to be arranged over touch-generating pads 121-126, although any configuration can be used that allows some coupling between the buttons and the pads either directly or through one or more other elements so that activation of a button can activate an associated pad. In the embodiment shown, a substantial portion of touch sensor 115 remains uncovered and can be used like a conventional touch screen. In some embodiments, the uncovered portion can be large enough to allow viewing of an entire display screen. Touch-generating pads 121-126 and tactile buttons 131-136 enhance the utility of touch sensor 115 by providing tactile feedback to users. Touch-generating pads 121-126 and tactile buttons 131-136 may be selectively installed at the time of manufacturing, depending on the application. This allows the manufacturing process to be simplified, even for multiple applications. Touch-generating pads 121-126 and tactile buttons 131-136 may also be configured for installation by users to maximize versatility.

It is to be understood that tactile touch-sensing system 100 provides a simple way to configure a touch-sensing system to provide users with tactile feedback. Conventional touch screens typically provide a smooth surface for receiving touches, which essentially provide no tactile feedback. Some electronic devices combine a touch-sensing system with a conventional control circuit with buttons and switches to achieve the above-mentioned advantages for having tactile feedback. However, these types of hybrid setups are much more complicated and expensive to manufacture and configure than simply having one touch sensor.

Tactile buttons may also be configured to provide texturing on their surfaces. The texturing can enable users to determine the function of the buttons by touching them. For example, tactile buttons 134 and 136 are shown textured with elevated symbols, which intuitively communicate the functions of the buttons to users by a sense of touch. In applications where users may suffer from visual or hearing impairments, buttons 131-133 and 135, which are textured with Braille, may be used.

FIGS. 4 and 5 are highly schematic cross-sectional views of an exemplary tactile button 403 and a touch-generating pad 407. For ease of illustration, tactile button 403 is shown as a snap dome button. However, many other types of buttons that provide similar tactile characteristics are covered by the invention. Also, FIGS. 4 and 5 illustrate a configuration of tactile button 403 and touch-generating pad 407 with a capacitive touch sensor 410. It is to be understood that similar tactile buttons and touch-generating pads may be configured on other types of touch sensors to provide tactile feedback to users.

FIG. 4 shows tactile button 403 and touch-generating pad 407 in an inactive state. In this state, touch-generating pad 407 is floating so it does not generate a touch on touch sensor 410. For capacitive touch sensors, touch-generating pad 407 can be floating when it is not tied to an electrical potential that will generate a signal on the touch sensor 410. As another example, in capacitive touch sensors, the touch-generating pad can be driven with a guard or shield signal that is ignored by the controller. For other types of touch sensors, any configuration such that touch-generating pad 407 does not generate a touch on touch sensor 410 when touch-generating pad 407 is in an inactive state is considered floating and within the scope of the invention.

FIG. 5 shows touch-generating pad 407 in an activated state. Tactile button 403, which is shown as being grounded in this example, has an electrical potential that is different from that of touch-generating pad 407. As shown in the figure, tactile button 403 is pressed by a user, which causes tactile button 403 to electrically connect to touch-generating pad 407. This connection results in a change in electrical potential of touch-generating pad 407 and, thus, causing a touch on touch sensor 410.

The mechanical property of tactile button 403, which is shown as a snap dome button in this example, causes a responsive force 415 in the opposite direction of the force exerted by the user to press button 403. Responsive force 415, which has the tendency to snap button 403 back to the inactive state, is felt by the user as a tactile feedback. It is to be appreciated that buttons with similar tactile feedback properties are well known in the art and will not be described in more detail. However, these buttons are all within the scope of the present invention.

The above specification, examples and data provide a complete description of the invention. Since many embodiments of the invention can be made without departing from the spirit and scope of the invention, the invention resides in the claims hereinafter appended.

1. A touch-sensing system comprising:
a touch sensor configured to produce an electrical signal in response to a touch input;
a touch-generating pad proximate to at least a portion of the touch sensor; and
a tactile button associated with the touch-generating pad, the tactile button configured to provide tactile feedback and to couple to the touch-generating pad upon activation by a user, the touch sensor configured to detect the coupling of the tactile button with the touch-generating pad.

2. The touch-sensing system of claim 1, wherein the tactile button is configured to provide a responsive force in response to being pressed by the user, the responsive force being operative to provide tactile feedback to the user.

3. The touch-sensing system of claim 1, wherein coupling the tactile button with the touch-generating pad electrically couples the touch-generating pad to the touch sensor.

4. The touch-sensing system of claim 1, wherein the tactile button is located remotely from the touch pad.

5. The touch-sensing system of claim 1, wherein the tactile button is located behind the touch senor.

6. The touch-sensing system of claim 1, wherein the tactile button has an electrical potential different than that of the touch-generating pad, and wherein the tactile button activates the touch-generating pad by electrically connecting to and changing the electrical potential of the touch-generating pad.

7. The touch-sensing system of claim 6, wherein the electrical potential of the tactile button is circuit ground.

8. The touch-sensing system of claim 1, wherein when the tactile button couples the touch-generating pad, the touch-generating pad is configured to mechanically contact the touch sensor sufficient to cause a detectable touch on the touch sensor.

9. The touch-sensing system of claim 1, wherein when the tactile button couples the touch-generating pad, the touch-generating pad is configured to break a light beam emitted by the touch sensor sufficient to cause a detectable touch on the touch sensor.

10. The touch-sensing system of claim 1, wherein when the tactile button couples the touch-generating pad, the touch-generating pad is configured to absorb the energy of an acoustic wave sufficient to cause a detectable touch on the touch sensor.

11. The touch-sensing system of claim 1, wherein when the tactile button couples the touch-generating pad, the touch-generating pad is configured to produce a vibration that is detectable as a touch on the touch sensor.

12. The touch-sensing system of claim 1, wherein the touch-generating pad is removably attached to the touch sensor.

13. The touch-sensing system of claim 1, wherein the touch-generating pad is permanently attached to the touch sensor.

14. The touch-sensing system of claim 1, wherein the tactile button includes texturing that enables the user to determine by a sense of touch the function of an input associated with the tactile button.

15. A system for interacting with a user comprising:
a display screen;
a touch sensor positioned in front of the display screen, the touch sensor being configured to produce a signal in response to a touch input;
a touch-generating pad positioned in front of the touch sensor, the touch-generating pad being configured such that the touch-generating pad, when not activated, does not cause a detectable touch on the touch sensor and, when activated, causes a detectable touch on the touch sensor; and
a tactile button associated with the touch-generating pad, the tactile button, when pressed by a user, being configured to activate the touch-generating pad.

16. The system of claim 15, wherein the tactile button is configured to provide a responsive force in response to being pressed by the user, the responsive force is sufficient to provide tactile feedback to the user.

17. The system of claim 15, wherein the tactile button is a snap dome button.

18. The system of claim 15, wherein the tactile button is a silicone elastomeric button.

19. The system of claim 15, wherein the tactile button is a rocker switch.

20. The system of claim 15, wherein the tactile button is a carbon button.

21. The system of claim 15, wherein the touch sensor is a capacitive touch sensor.

22. The system of claim 21, wherein when not activated, the touch-generating pad is configured not to capacitively couple with the touch sensor.

23. The system of claim 21, wherein in response to being activated, the touch-generating pad is configured to capacitively couple with the touch sensor.

24. The system of claim 15, wherein the touch sensor is a resistive touch sensor.

25. The system of claim 24, wherein if not active, the touch-generating pad is configured not to mechanically contact the resistive touch sensor.

26. The system of claim 24, wherein in response to being activated, the touch-generating pad is configured to mechanically contact the resistive touch sensor.

27. The system of claim 15, wherein the touch sensor is an optical touch sensor.

28. The system of claim 27, wherein when not active, the touch-generating pad is configured not to block light beams emitted by the optical touch sensor.

29. The system of claim 27, wherein in response to being activated, the touch-generating pad is configured to block a light beam emitted by the optical touch sensor.

30. The system of claim 15, wherein the touch sensor is a surface acoustic wave touch sensor.

31. The system of claim 30, wherein when not active, the touch-generating pad is configured not to absorb energy of acoustic waves emitted by the surface acoustic wave touch sensor.

32. The system of claim 30, wherein in response to being activated, the touch-generating pad is configured to absorb sufficient energy of the acoustic waves emitted by the surface acoustic wave touch sensor.

33. The system of claim 15, wherein the touch sensor is a vibration-sensing touch sensor.

34. The system of claim 33, wherein when not active, the touch-generating pad is configured not to cause vibrations in the vibration-sensing touch sensor.

35. The system of claim 33, wherein in response to being activated, the touch-generating pad is configured to cause vibrations that can be sensed by the vibration-sensing touch sensor.

36. A method for providing tactile feedback to a user of a touch-sensing system, the touch-sensing system includes a touch sensor, the method comprising:
attaching a touch-generating pad onto the touch sensor in such a way that when not activated, the touch-generating pad does not cause a touch on the touch sensor; and
in response to the user pressing a tactile button associated with the touch-generating pad, activating the touch-generating pad and providing tactile feedback to the user; and
in response to activating the touch-generating pad, causing a touch on the touch sensor.

37. The method of claim 36, wherein in response to the user pressing the tactile button, providing a responsive force as tactile feedback to the user.

38. The method of claim 36, wherein causing the touch on the touch sensor is performed by capacitively coupling the touch-generating pad with the touch sensor.

39. The method of claim 36, wherein causing the touch on the touch sensor is performed by a mechanical contact between the touch-generating pad and the touch sensor.

40. The method of claim 36, wherein causing the touch on the touch sensor is performed by blocking a light beam emitted by the touch sensor with the touch-generating pad.

41. The method of claim 36, wherein causing the touch on the touch sensor is performed by absorbing the energy of an acoustic wave emitted by the touch sensor using the touch-generating pad.

42. The method of claim 36, wherein causing the touch on the touch sensor is performed by impacting the touch sensor in a manner sufficient to cause a detectable vibration in the touch sensor.
